(19) United States
(12) Patent Application Publication
(10) Pub. No.: US 2014/0232210 A1
(43) Pub. Date: Aug. 21, 2014

(54) Core for a Primary of a Linear Induction Motor

(71) Applicant: Alireza Safaee, Kingston (CA)

(72) Inventor: Alireza Safaee, Kingston (CA)

(73) Assignee: BOMBARDIER TRANSPORTATION GMBH, Berlin (DE)

(21) Appl. No.: 14/349,560

(22) PCT Filed: Nov. 2, 2011
(86) PCT No.: PCT/CA2011/001235

§ 371 Date: Apr. 3, 2014

(51) Int. Cl. H02K 41/02

(52) U.S. Cl. CPC H02K 41/02
USPC 310/12.29

(57) ABSTRACT

A core for a primary of a liner induction motor. The core includes a number of laminate sheets positioned between two walls of a frame. Each laminate sheet of the plurality of laminate sheets includes a number of heat dissipating projections positioned in a spaced apart manner along a longitudinal edge of the laminate sheet. The heat dissipating projections of each pair of adjacent laminate sheets are staggered from one another such that the core upper surface includes interleaving heat dissipating projections.

### FIELD OF THE INVENTION

The present invention relates to the field of linear induction motors, and more particularly to a laminate core for a primary of a linear induction motor that provides heat dissipation via a plurality of interleaved projections.

### BACKGROUND OF THE INVENTION

Electric motors are gaining in popularity as the need for more economical and environmental forms of transportation increases around the world. However, as the demand for electric motors increases, so does the demand for more efficient electric motors that have improved performance and reliability.

Linear induction motors (LIMs) are non-rotary electric motors that provide propulsion in a linear direction, making them suitable for many applications such as within railway vehicles that travel along a pre-determined linear path defined by the rails. Therefore, a common application for LIMs is in the railway transportation industry for passenger rapid transit systems.

Linear induction motors generally comprise a primary and a secondary. The primary has coils and is driven by AC sources and the secondary is passive, and in the case of railway transit systems, is often positioned along the path of the rails. There are two structural possibilities when designing a linear induction motor, which are: (1) short-primary/long-secondary and (2) long-primary/short-secondary. In railway applications the first structure is favored. The primary portion is located on the underside of the railway vehicle and as mentioned above the passive secondary, which is often referred to as the reaction rail, is positioned along the path of the rails. The primary comprises a core and electromagnetic coils that when turned on, create a magnetic field with the reaction rail for propelling and supporting the railway vehicle along the non-powered electromagnets in the reaction rail.

The electromagnetic coils that are included within the primary of the LIM, are generally made of non-ideal materials such as copper or aluminum. As such, during operation of the LIM, energy dissipation happens in these coils in the form of heat. Due to the positive thermal resistance coefficient of the materials used to make these electromagnetic coils, as the temperature of the coils increases, the coil resistance also increases. This increased temperature reduces the overall efficiency of the motor.

In light of the above, it can be seen that there is a need in the industry for an improved primary for a linear induction motor that has improved thermal management capabilities, so as to improve on the overall efficiency of the linear induction motor arrangement.

### SUMMARY OF THE INVENTION

In accordance with a first broad aspect, the present invention provides a core for a primary of a linear induction motor. The core comprises a plurality of laminate sheets of a first type and a plurality of laminate sheets of a second type. Wherein each laminate sheet of the first type comprises a first set of coil-receiving slots and a first set of heat dissipating projections. And each laminate sheet of the second type comprises a second set of coil-receiving slots and a second set of heat dissipating projections. The core is formed by stacking the plurality of laminate sheets of the first type and the plurality of laminate sheets of the second type in an alternating arrangement, wherein when the first set of coil-receiving slots and the second set of coil-receiving slots are aligned with one another, the first set of heat dissipating projections and the second set of heat dissipating projections are staggered with respect to each other along a longitudinal surface of the core.

In accordance with a second broad aspect, the present invention provides a core for a primary of a linear induction motor. The core comprises a plurality of laminate sheets that are positioned in a stacked arrangement. Each of the laminate sheets comprises a plurality of coil-receiving slots for receiving coil windings of the linear induction motor and a plurality of heat dissipating projections. Each heat dissipating projection has a base portion and a top portion, wherein the top portion has a surface area of between 6 mm² and 16 mm² and the base portion has a surface area that is at least double that of the top portion.

In accordance with a third broad aspect, the present invention provides a core for a primary of a linear induction motor. The core comprises a plurality of laminate sheets positioned between two walls of a frame. Each laminate sheet of the plurality of laminate sheets comprises a plurality of heat dissipating projections positioned in a spaced apart manner along a longitudinal edge of the laminate sheet. The heat dissipating projections of each pair of adjacent laminate sheets are staggered from one another such that the core comprises an upper surface defined by a plurality of interleaving heat dissipating projections.

These and other aspects and features of the present invention will now become apparent to those of ordinary skill in the art upon review of the following description of specific embodiments of the invention and the accompanying drawings.

### BRIEF DESCRIPTION OF THE DRAWINGS

In the accompanying drawings:

FIG. 1 shows a perspective view of a core of a primary of a linear induction motor in accordance with the prior art;

FIG. 2 shows a perspective view of a non-limiting example of implementation of a core of a primary of a linear induction motor in accordance with the present invention;

FIG. 3 shows an expanded cut-away view of a portion of the core of FIG. 2.

FIG. 4A shows a non-limiting example of a laminate sheet of a first type for use in a core of a primary of a linear induction motor according to the present invention;

FIG. 4B shows a non-limiting example of a laminate sheet of a second type for use in a core of a primary of a linear induction motor according to the present invention;

FIG. 5 shows an expanded view of a portion of a laminate sheet of the first type and a portion of a laminate sheet of the second type stacked adjacent one another in accordance with a non-limiting example of implementation;

FIG. 6 shows an expanded view of a plurality of laminate sheets of the first type and a plurality of laminate sheets of the second type stacked adjacent one another in an alternating manner in accordance with a non-limiting example of implementation of the present invention;

FIG. 7 shows a cut-away view of the side of the core of the primary of a linear induction motor of FIG. 2.

Other aspects and features of the present invention will become apparent to those ordinarily skilled in the art upon review of the following description of specific embodiments of the invention in conjunction with the accompanying figures.

### DETAILED DESCRIPTION

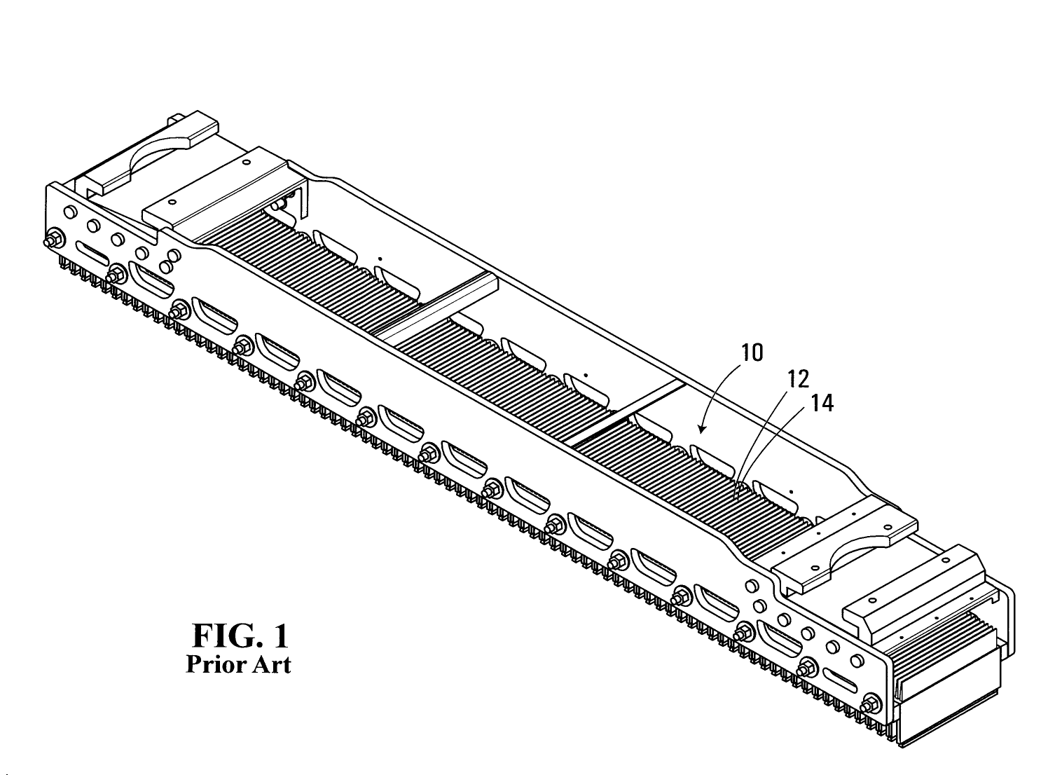

Shown in FIG. 1 is a prior art laminate core 10 for a primary of a linear induction motor. The laminate core 10 absorbs and dissipates heat from the electromagnetic coils (not shown) of the linear induction motor in order to remove some of the heat generated by the coils as well as the heat generated in the core itself from eddy and hysteresis losses. This prior art laminate core 10 comprises a plurality of longitudinal laminate sheets that when stacked adjacent each other, form a plurality of fins 12 and valleys 14 that extend in a direction perpendicular to the longitudinal axis of the core 10. The fins 12 provide increased surface area over which coolant air can flow, thereby dissipating the heat that is absorbed by the laminate sheets from the electromagnetic coils of the linear induction motor.

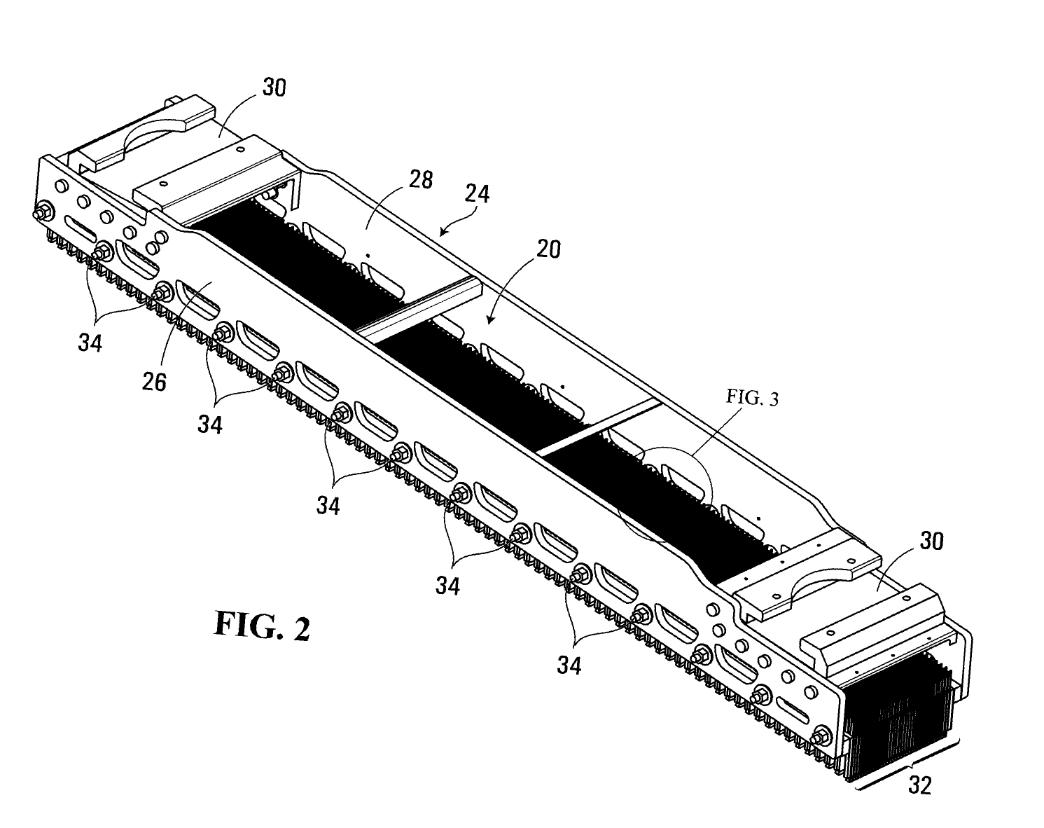

Shown in FIG. 2 is a laminate core 20 in accordance with a non-limiting example of implementation of the present invention for use in a primary of a linear induction motor. Although the present invention will be described herein in the context of a linear induction motor it should be appreciated that the laminate core 20 according to the present invention could also be used with rotary motors and/or generators.

As shown in the Figures, the laminate core 20 comprises an arrangement of stacked laminate sheets that provides improved heat dissipation over the fins 12 and valleys 14 of the prior art core 10. The laminate core 20 is supported by a frame 24 that attaches to the underside of a railway vehicle (not shown). The frame 24 comprises a pair of longitudinal frame walls 26, 28 and two top wall portions 30. The core 20 that is positioned between the longitudinal frame walls 26, 28 comprises a plurality of laminate sheets 32 that are secured to the two longitudinal frame walls 26, 28 by a set of bolts 34. The bolts 34 are located at spaced intervals along the length of the longitudinal frame walls 26, 28 and serve to hold the laminate sheets 32 tightly together between the two longitudinal frame walls 26, 28.

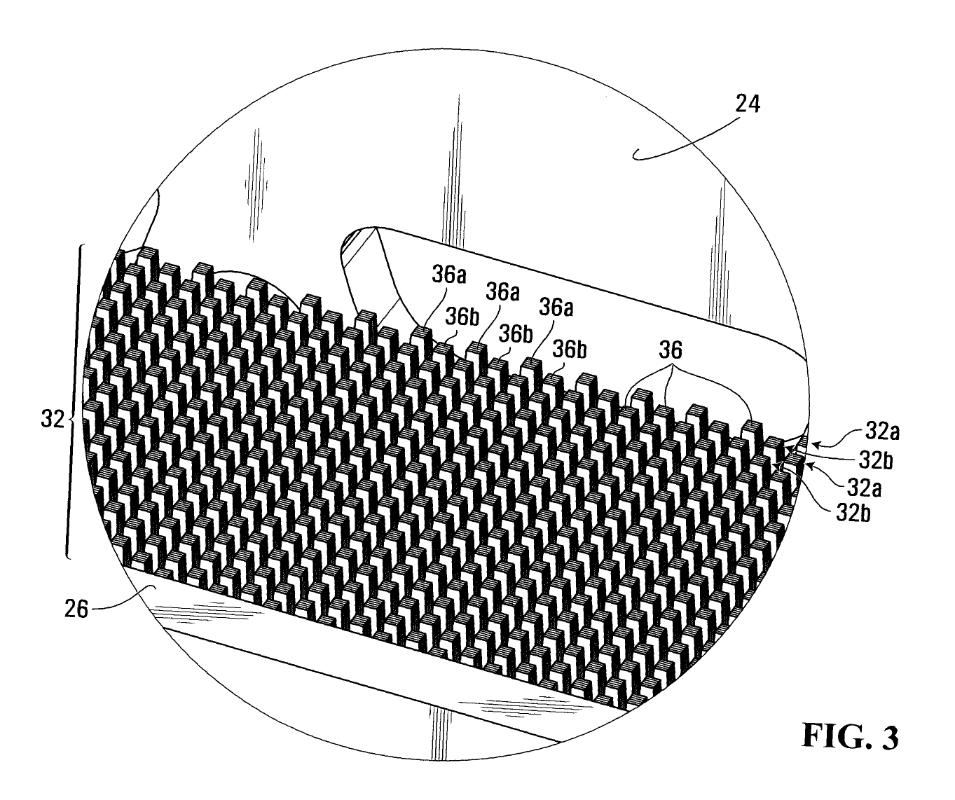

FIG. 3 shows an expanded view of a portion of the core 20 that better illustrates that when the plurality of laminate sheets 32 are stacked adjacent one another, the core 20 comprises an upper surface that is defined by a plurality of interleaved heat dissipating projections 36. As used herein, the term “interleaved” is used to mean that the heat dissipating projections 36 of two adjacent laminate sheets 32 are not positioned in alignment with each other, and are instead off-set or interspersed with respect to each other, such that there is very little, or no, contact between the surfaces of the heat dissipating projections 36. The heat dissipating projections 36 that are arranged in an interleaved fashion has been found to provide up to 30% more surface area than the fins 12 shown in FIG. 1, which improves the overall heat dissipation for the core and electromagnetic coils. This, in turn, improves the overall efficiency of the linear induction motor.

More specifically, the electromagnetic coils of the linear induction motor, which are generally made of copper or aluminum, have positive thermal resistance coefficients, which means that at higher temperatures the coil resistance increases and the efficiency is reduced (the current values are constant for the same output power). Having more resistance in constant current means that the inverter should supply more active power. By providing the laminate core 20 with the interleaved heat dissipating projections 36, more surface area is provided to the coolant air, which facilitates the heat transfer. With easier heat flow out of the core 20, the temperature is able to remain lower and the heat exchange between the coils and the laminate core 20 is also improved. The more heat that is able to be extracted from the electromagnetic coils, keeps their electrical resistance in the lower range which directly impacts the efficiency of the motor. Not only does this improved thermal management help to improve the efficiency of the coils, it also increases their performance reliability and cost effectiveness over their expected life span.

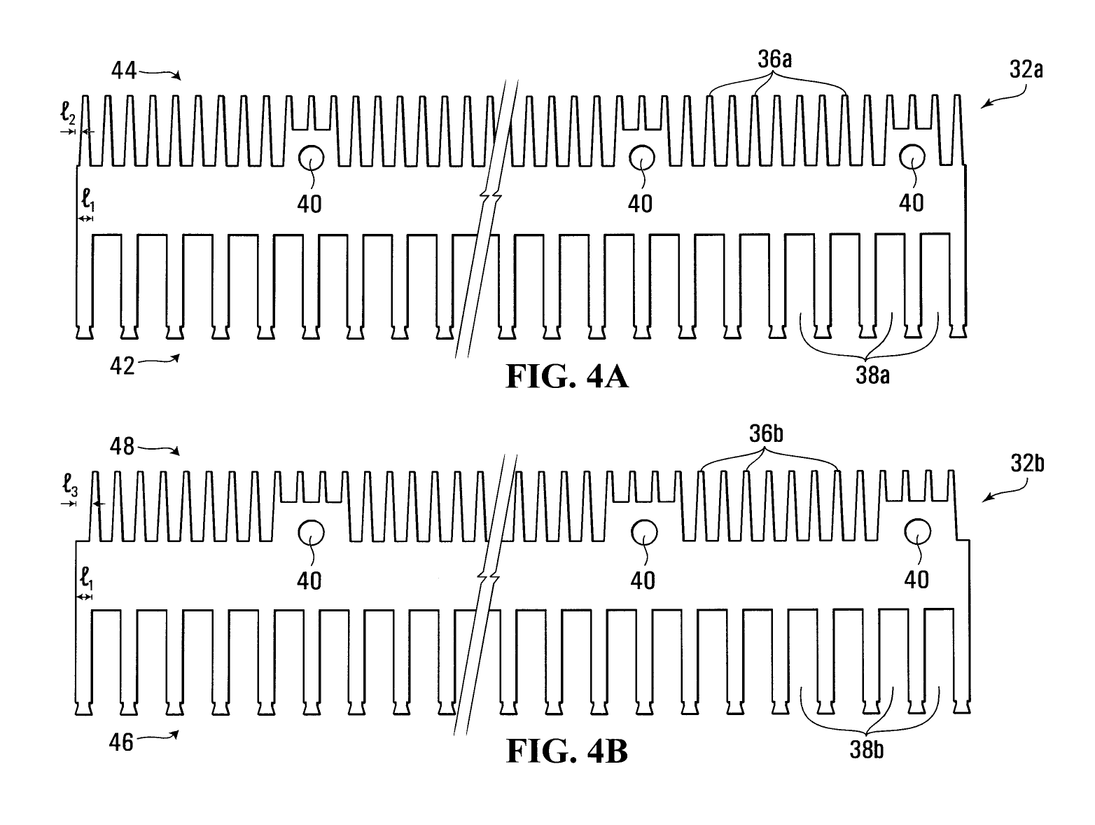

In accordance with a non-limiting example of implementation, the plurality of laminate sheets 32 that are stacked adjacent one another to form the laminate core 20 comprise a plurality of laminate sheets 32a of a first type and a plurality of laminate sheets 32b of a second type. As shown in FIG. 3, the laminate sheets 32a of the first type and the laminate sheets 32b of the second type provide heat dissipating projections 36a, 36b, that are staggered with respect to each other. More specifically, the laminate sheets 32a of the first type comprise heat dissipating projections 36a, and the laminate sheets 32b of the second type comprise heat dissipating projection 36b. The laminate sheets 32a of the first type and the laminate sheets 32b of the second type are stacked adjacent one another in an alternating arrangement such that their heat dissipating projections 36a and 36b are staggered, or off-set, with respect to each other. This will be described in more detail with respect to FIGS. 4A-4B, 5 and 6.

Shown in FIG. 4A is a front plan view of a laminate sheet 32a of the first type and shown in FIG. 4B is a front plan view of a laminate sheet 32b of the second type. When a plurality of laminate sheets 32a of the first type and a plurality of laminate sheets 32b of the second type are stacked adjacent one another in an alternating fashion, they will be referred to collectively as the plurality of laminate sheets 32 (as shown in FIG. 3), for the sake of simplicity.

With reference to FIG. 4A, the laminate sheet 32a of the first type comprises a set of coil-receiving slots 38a along a bottom longitudinal edge 42 of the sheet 32a, and a set of heat dissipating projections 36a positioned in a spaced-apart manner along a top longitudinal edge 44. Similarly, with reference to FIG. 4B, the laminate sheet 32b of the second type comprises a set of coil-receiving slots 38b along a bottom longitudinal edge 46 of the sheet 32b, and a set of heat dissipating projections 36b positioned in a spaced-apart manner along a top longitudinal edge 48. The coil-receiving slots 38a, 38b are included to receive the electromagnetic coil windings from the primary of the linear induction motor (not shown) and the heat dissipating projections 36a, 36b are included in order to provide increased surface area over which coolant air can flow, such that the heat that is absorbed from the electromagnetic coils can be more efficiently dissipated.

As shown in FIGS. 4A and 4B, the heat dissipating projections 36a of the laminate sheet 32a of the first type are evenly spaced along the length of the laminate sheet 32a. In addition, the heat dissipating projections 36b of the laminate sheet 32b of the second type are also evenly spaced along the length of the laminate sheet 32b. Furthermore, the distance (which can also be called the pitch) between two adjacent heat dissipating projections 36a on the laminate sheet 32a is the same as the distance (or pitch) between two adjacent heat dissipating projections 36b on the laminate sheet 32b. However, in alternative embodiments of the present invention, the heat dissipating projections 36a or 36b, may not be evenly spaced along the length of their respective laminate sheets 32a, 32b, and the pitch of the heat dissipating projections 36a may be different from the pitch of the heat dissipating projections 36b.

Both the laminate sheets 32a and 32b comprise a plurality of apertures 40 positioned in a spaced apart manner along their lengths for receiving bolts 34 that will connect the plurality of laminate sheets 32 (including laminate sheets 32a, 32b of both the first and second types) together. The bolts 34 extend through the apertures 40 for tightly holding the plurality of laminate sheets 32 between the longitudinal frame walls 26, 28 of the frame 24.

As mentioned above, in order to form the laminate core 20 according to the present invention, a plurality of the laminate sheets 32a of the first type and a plurality of the laminate sheets 32b of the second type are stacked adjacent one another in an alternating fashion between the longitudinal frame walls 26, 28 of the frame 24. More specifically, the plurality of laminate sheets 32 (including both laminate sheets 32a and 32b) are stacked adjacent each other in accordance with an alternating pattern of: laminate sheet 32a, laminate sheet 32b, laminate sheet 32a, laminate sheet 32b, etc. It should be understood that the pattern could commence and finish with either laminate sheet 32a of the first type or laminate sheet 32b of the second type, without departing from the spirit of the invention.

Referring back to FIGS. 4A and 4B, the heat dissipating projections 36a of the laminate sheet 32a are positioned differently in relation to the apertures 40 than the heat dissipating projections 36b of the laminate sheets 32b. This causes the heat dissipating projections 36b to be staggered with respect to heat dissipating projections 36a when the laminate sheets 32a and 32b are stacked adjacent each other in an alternating fashion.

As shown in FIG. 4a, the apertures 40 of laminate sheet 32a are centered with respect to given ones of the heat dissipating projection 36a. However, and as shown in FIG. 4b, the apertures 40 of laminate sheet 32b are centered between two adjacent ones of the heat dissipating projections 36b. As such, when bolts are passed through the apertures 40 of the laminate sheets 32a of the first type and laminate sheets 32b of the second type, the heat dissipating projections 36a will be staggered with respect to the heat dissipating projections 36b. This difference in the positioning of the projections 36a, 36b with respect to the apertures 40 of their respective laminate sheets 32a, 32b creates the staggering or interleaving of the projections 36a, 36b.

Although in the example described above the apertures 40 of the laminate sheets 32a were centered with respect to a heat dissipating projection 36a, and the apertures 40 of the other laminate sheet 32b were centered between two adjacent heat dissipating projections 36b, it should be understood that the projections 36a and 36b could be positioned in any manner in relation to the apertures 40 of their respective laminate sheet 32a, 32b, so long as the positioning of the projections 36a, 36b in relation to the apertures 40 of their respective laminate sheet 32a or 32b is different.

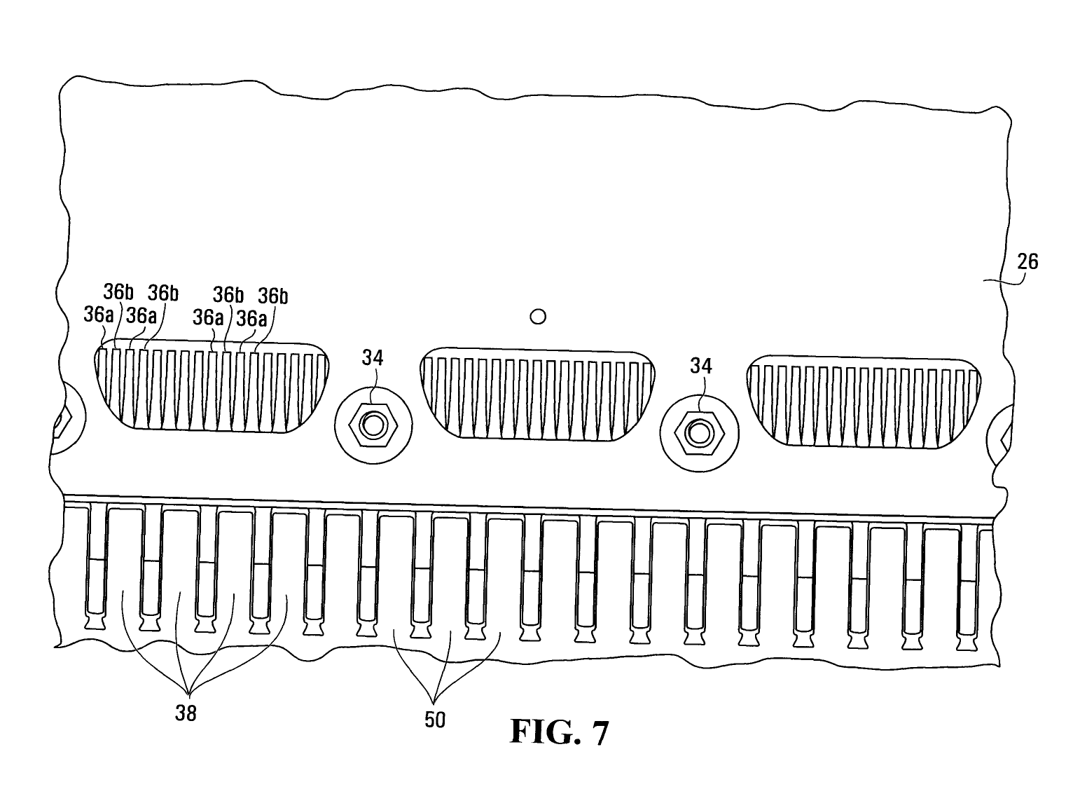

Referring once again back to FIGS. 4A and 4B, the coil-receiving slots 38a, 38b of the laminate sheets 32a, 32b are positioned in the same manner in relation to the apertures 40 of their respective laminate sheets 32a, 32b. As such, when a set of laminate sheets 32a of the first type and a set of laminate sheets 32b of the second type are stacked adjacent to one another in an alternating pattern by the bolts 34, the coil-receiving slots 38a, 38b of the laminate sheets 32a, 32b are positioned in alignment with each other. As will be described in more detail below, this alignment of the coil-receiving slots 38a, 38b allows them to form continuous slots 38 (shown in FIG. 7) for receiving the electromagnetic coils of the linear induction motor.

The laminate sheets 32a and 32b may be of the same length, as shown in FIGS. 4A and 4B, or alternatively, may be of different lengths. In the case where the laminate sheets 32a, 32b are of the same length, the coil-receiving slots 38a, 38b start at the same distance, l₁, from an edge of the laminate sheets 32a, 32b. As such, when the plurality of laminate sheets 32 (including both laminate sheets 32a and 32b) are connected together by the bolts 34, the slots 38a, 38b of the laminate sheets 32a, 32b, are positioned in alignment with each other to form continuous slots 38. This is best shown in FIG. 7, which shows a side view of the laminate core 20 of FIG. 2.

The continuous slots 38 are positioned substantially perpendicular to the length of the laminate sheets 32a, 32b and extend from one longitudinal frame wall 26 to the other longitudinal frame wall 28. These continuous slots 38 are operative for receiving the electromagnetic coils (not shown) of the linear induction motor, which are helically wound through the slots 38 and are secured within the slots 38 by keys (not shown) that co-operate with the dovetail formations 50 at the lower end of each of the slots 38. Although dovetail formations 50 are shown in the Figures, it should be appreciated that the coils of the linear induction motor can be secured within the slots 38 using any technique known in the art. Although not shown in the Figures, the coils of the linear induction motor generally extend beyond the core 20.

Referring back to FIGS. 4A and 4B, in the case where the laminate sheets 32a, 32b are of the same length, the heat dissipating projections 36a, 36b of each laminate sheet 32a, 32b will be off-set differently from the edges of the sheets 32a, 32b. For example, the heat dissipating projections 36a and 36b, start at different distances, l₂ and l₃, respectively, from the edge of the laminate sheets 32a, 32b. In this manner, given that the coil-receiving slots 38a, 38b of the two different laminate sheets 32a, 32b are positioned at the same distance l₁, from the edge of the laminate sheets 32a, 32b, the heat dissipating projections 36a, 36b are staggered, or off-set, differently in relation to the coil-receiving slots 38a, 38b.

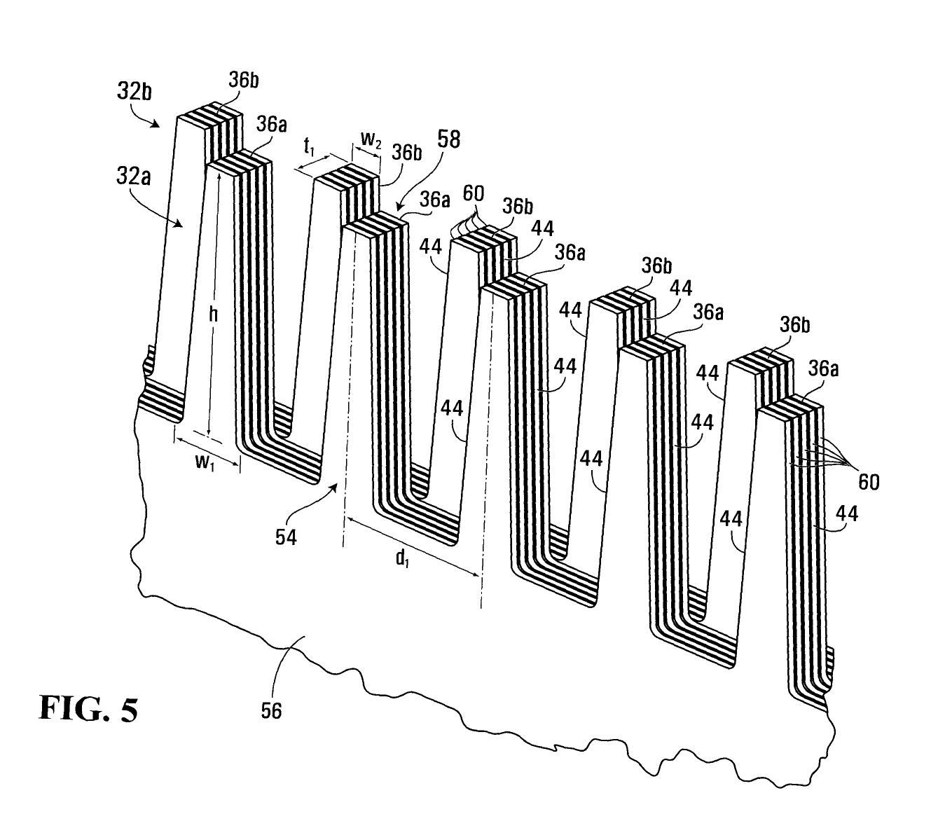

Shown in FIG. 5 is an expanded view of a laminate sheet 32a of the first type and a laminate sheet 32b of the second type stacked adjacent to each other. This positioning is achieved once a bolt 34 has been placed through the apertures 40 in the two laminate sheets 32a, 32b for holding them together. As shown, the heat dissipating projections 36a, 36b of these two laminate sheets 32a, 32b are staggered or interleaved with respect to each other. In addition, each of the projections 36b of the laminate sheet 32b is positioned substantially centrally between two adjacent projections 36a of the laminate sheet 32a. However, it should be appreciated that in alternative embodiments, particularly when the pitch between the projections 36a, 36b is different, the projections 36b of the laminate sheet 32b may not be positioned centrally between two projections 32a, and instead may be positioned closer to one of the adjacent projections 36a than the other.

The configuration of each heat dissipating projections 36a, 36b will now be described in more detail with respect to FIG. 5. As shown, each of the heat dissipating projections 36a, 36b has a generally trapezoidal shape, with a base portion 54 that is proximal to the body 56 of its laminate sheet 32a or 32b, and a top portion 58 that is distal from the body 56 of its laminate sheet 32a or 32b. Each of the heat dissipating projections 36a, 36b has a thickness t₁ that is substantially uniform from its base portion 54 to its top portion 58. This thickness t₁ is also generally uniform for the entire laminate sheet 32a, 32b from which the heat dissipating projections 36a, 36b extend. However, the width of each heat dissipating projection 36a, 36b diminishes from its base portion 54 to its top portion 58.

More specifically, the base portion 54 of each heat dissipating projection 36a, 36b has a width W₁, and the top portion 58 has a width W₂. The width W₁ of the base portion 54 is greater than the width W₂ of the top portion 58. In accordance with a non-limiting example of implementation, the width W₁ of the base portion 54 is approximately twice the width W₂ of the top portion 58.

This trapezoidal shape provides efficient heat dissipation for the heat dissipating projections 36a, 36b. If the top portion 58 of the projections 36a, 36b is too wide, there is inefficiency in heat transfer, and if the bottom portion 54 of the projections 36a, 36b is too thin, there is not sufficient heat absorbency from the electromagnetic coils. The temperature difference, At, between the ambient air and the lamination surface acts as the driving force for heat transfer. At the bottom of the protrusion, the temperature difference, At, is high so more solid material is needed to reduce the heat-transfer resistance. Higher in the protrusion height, the temperature difference, At, reduces and the possible heat exchange is lower so the material can be thinner.

Given that the thickness t₁ of the heat dissipating projection 36 remains substantially constant, and the width of each projection 36a, 36b decreases from the base portion 54 towards the top portion 58, the surface area of the top portion 58 is smaller than the surface area of the bottom portion 54. The surface area of the bottom portion 54 can be obtained by multiplying the width W₁ of the base portion with the thickness t₁, which would be the cross-sectional surface area of the base portion 54 if a projection 36a, 36b were to be cut from its laminate sheet 32a, 32b at the location where the projection 36 starts to extend from the body 56 of the laminate sheet 32a, 32b. The surface area of the top portion 58 can be obtained by multiplying the width W₂ of the top portion 58 with the thickness t₁. In accordance with a non-limiting example of implementation, the top portion 58 has a cross sectional surface area that is between ½ and ¼ of the surface area of the bottom portion 54.

In accordance with a non-limiting example of implementation, the thickness t₁ of the projections 36a, 36b is between 2 mm and 4 mm. The width W₁ of the projections 36a, 36b at their base portion 54 is between 3 mm and 8 mm and the width W₂ of the projections 36a, 36b at their top portion 58 is between 2 mm and 4 mm. However, it should be appreciated that these dimensions are provided for the sake of example only, and that other dimensions could also be used without departing from the present invention.

In the embodiment shown, the projections 36a, 36b have a substantially rectangular or square cross-section, depending on where the cross section is taken. For example, given that the thickness t₁ remains substantially constant, the projections 36a, 36b have a substantially rectangular cross section at their base portion 54 and a substantially square cross section at their top portion 58. It has been found that good heat dissipation occurs when the projections 36a, 36b have a top portion having a square-shaped cross section. If the thickness t₁ becomes too great, the amount of heat dissipation provided by the projections 36a, 36b decreases. However, heat dissipating projections 36a, 36b that have cross-sectional shapes different from square or rectangular are also included within the present invention.

Each of the projections 36a, 36b also has a height “h”. The height h of each of the projections 36a, 36b may be the same, or alternatively, the height “h” of each projection 36a, 36b may be different. For example, the height “h” of the projections 36a may be different from the height “h” of the projections 36b. Or alternatively, the height “h” of some of the projections 36a may be different from the height “h” of other ones of the projections 36a. This may also be the case for the projections 36b. In accordance with a non-limiting example of implementation, the height “h” of the projections 36a, 36b may be in the range of 25 mm to 45 mm, and more specifically may be in the range of 32 mm to 37 mm. The height “h” of the projections 36a, 36b will depend at least in part on the amount of heat exchange desired from the laminate core 20.

There are many factors that may influence the desired height “h” and widths W₁ and W₂ of the projections, such as the amount of air flow that will pass over the core 20, the temperature difference between the ambient air and the electromagnetic coils, and the amount of space located underneath the vehicle bogie. A person of skill in the art would be able to determine the appropriate height “h” and widths W₁ and W₂ for the projections 36a, 36b taking into consideration the above described factors, as well as other factors known to impact the heat dissipation. Depending on the application and the environmental factors, the height “h” and widths W₁ and W₂ can be modified in order to arrive at a desired heat exchange profile.

In general, in order to obtain good heat exchange between the core and the coolant air, a large amount of surface area is needed. However, there is also a balance needed between the amount of surface area provided by the projections 36a, 36b and the ability for air to flow around the projections. In other words, if the projections 36a, 36b are too tightly packed together, the flow of air is not able to effectively remove the heat. Therefore, in order to obtain a good balance between the surface area that is provided by the projections 36a, 36b, and the flow of air that is able to travel over the projections 36a, 36b, the projections 36a, 36b are arranged on their respective laminate sheets 32a, 32b such that a ratio of the distance d₁ between two adjacent heat dissipating projections to a width W₁ of the base portion 54 of a heat dissipating projection 36a, 36b is between 2 to 4. The distance d₁ (or pitch) between two adjacent heat dissipating projections is measured from a center of one heat dissipating projection 36a or 36b to a center of an adjacent heat dissipating projection 36a or 36b on the same laminate sheet 32a or 32b. In accordance with a more specific, non-limiting example of implementation, the ratio of d₁ to W₁ is between 3 to 3.5. As has been mentioned above, it has been found that this ratio of d₁ to W₁ provides good airflow over the projections and enough surface area provided by the projections 36a, 36b to dissipate the heat effectively. When the ratio of d₁ to W₁ is less than 2, the projections are too tightly packed together such that there is insufficient air flow to dissipate the heat, and when the ratio of d₁ to W₁ is greater than 4, there is good air flow but insufficient surface area to adequately dissipate the heat.

In accordance with the non-limiting example of implementation shown in FIG. 5, each of the projections 36a, 36b is symmetric about a central plane that extends through the center of a projection from one longitudinal surface of the sheet to the other longitudinal surface of the sheet. As such, each of the side edges 44 of the projections 36a, 36b slants towards the top portion at the same angle. The symmetry of the projections 36a, 36b makes them relatively easy to manufacture. However, in an alternative embodiment, the projections 36a, 36b may be asymmetric and have one side surface 44 that has a greater slant than the other side surface 44. This may provide the laminate sheets 32a, 32b with a more “wave-like” appearance.

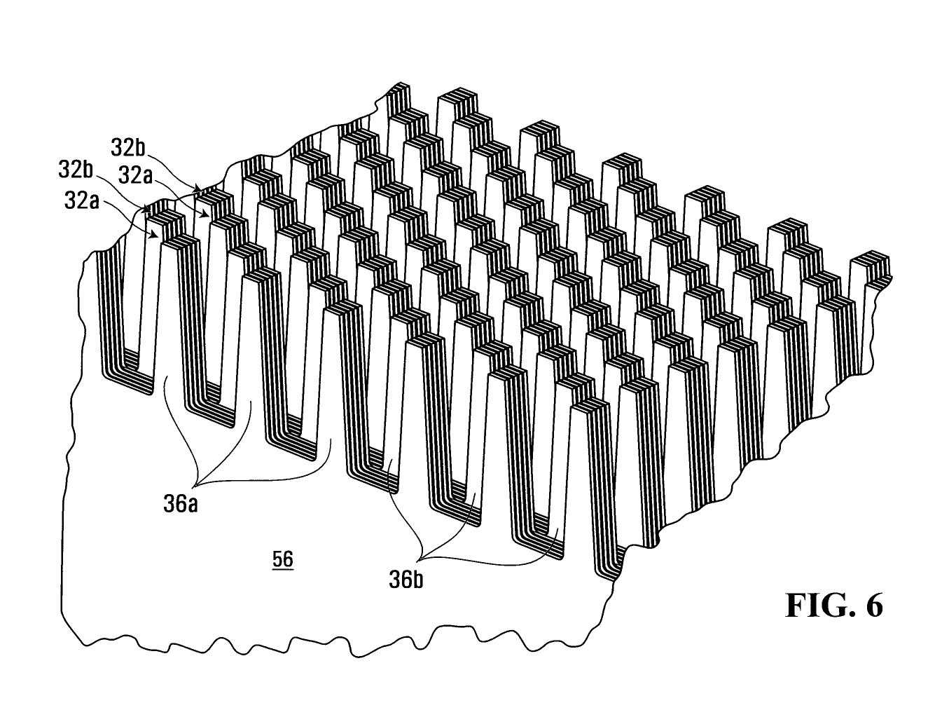

The manner in which the laminate sheets 32a, 32b are manufactured will now be described in more detail with respect to FIGS. 5 and 6. In accordance with a non-limiting example of implementation, each of the laminate sheets 32a, 32b is formed of a plurality of laminate layers 60 that together provide a laminate sheet 32a, 32b having the thickness t₁. In the non-limiting embodiment shown in FIG. 5, each of the laminate sheets 32a, 32b is formed of five laminate layers 60. However more or fewer laminate layers 60 may be used to form a laminate sheet 32a, 32b, without departing from the spirit of the invention, such as 4 or 6 layers, for example.

Each laminate layer 60 is formed from a sheet of magnetic material, which could be an electrical steel, among other possibilities known in the art. In accordance with a non-limiting example of implementation, each layer 60 is formed of a material referred to as AISI M36, which is a Molybdenum high speed steel that includes a composition of elements including Cobalt (Co), Tungsten (W), Molybdenum (Mo), Chromium (Cr) and Vanadium (V), among other elements. However, other types of silicon steel having grades of M19, M27 or M43, can also be used.

In addition, each sheet of magnetic material from which a laminate layer 60 is formed is oxidized to form a layer of oxidation thereon. This layer of oxidation provides insulation such that the laminate layer 60 may be insulated from an adjacent laminate layer 60. Although oxidation is described herein, it should be appreciated that the laminate layers 60 may be insulated from one another using other techniques known in the art as well. For example, C-5 insulation could be used. This inorganic-based surface insulation (equivalent to ASTM Type C-5 coating) is suggested for use where superior insulation is required after a stress-relief anneal. It provides a uniform, high-resistance insulation for the more severe requirements of large electrical apparatus. C-5 insulation has a minimum effect on lamination factor. It can be exposed to ordinary stress-relief annealing temperatures without impairment of its superior insulation resistance when specified protective annealing atmospheres are used. In addition, C-5 insulation is not affected by oils, and provides some rust resistance. A small amount of organic material is contained in C-5 insulation to enhance die life relative to the standard surface finish and C-4 insulation. C-5 insulation is especially useful in large transformers made with stacked, flat laminations and in large motors and generators.

In accordance with a non-limiting example of implementation, each laminate layer 60 is formed by a punch-and-press technique, wherein a punch is applied to a sheet of magnetic material in order to punch from the sheet of magnetic material the shape of a laminate layer 60 for one of the laminate sheets 32a or 32b. A first punch is used in order to punch out a laminate sheet 60 having the shape of the laminate sheet 32a as shown in FIG. 4A. And a second punch is needed in order to punch out a laminate sheet 60 having the shape of the laminate sheet 32b shown in FIG. 4B. When performing the punching operation, a punch may be applied to a single sheet of magnetic material, such that only one laminate layer 60 is formed, or alternatively, the punch may be applied to multiple sheets of magnetic material, such that multiple ones of the laminate layers 60 are formed. In accordance with a non-limiting example, a punch may be applied simultaneously to a pile of 5 sheets of magnetic material such that five laminate layers 60 are formed. In this manner, with one punching operation, one full laminate sheet 32a or 32b could be formed. In the case where only one laminate sheet 60 is formed at a time, then by placing five (or another number) of the laminate layers 60 that were punched by the same punch together, one full laminate sheet 32a or 32b is formed.

In accordance with the present invention, there is no adhesive or other bonding agent between the laminate layers 60 of a given laminate sheet 32a or 32b. Instead, the plurality of laminate layers 60 that forms a given laminate sheet 32a, 32b are kept together by the bolts 34.

In an alternative, non-limiting embodiment, the laminate layers 60 can be formed in accordance with other techniques, and not via the punch-and-press operation described above. For example, the laminate layers 60 having the shape of either the laminate sheet 32a or 32b may be cut from a sheet of magnetic material via water jet cutting, laser cutting or wire cutting, among other possibilities. One laminate layer 60 of material may be cut at a time, or alternatively, multiple layers 60 of material may be cut at the same time.

In accordance with a non-limiting embodiment, each laminate layer 60 that goes into forming the laminate sheet 32a, 32b has a thickness of between 0.4 mm and 0.8 mm. In a more specific non-limiting embodiment, each laminate layer 60 has a thickness of approximately 0.6 mm, such that when five of the laminate layers 60 are positioned adjacent each other to form the laminate sheets 32a, 32b, the laminate sheets 32a, 32b have a thickness t₁ of approximately 3 mm, as described above.

Shown in FIG. 6 is a cut-away portion of the laminate core 20 that comprises laminate sheets 32a, 32b stacked adjacent one another in an alternating fashion. As shown, the projections 36a and 36b of these laminate sheets 32a, 32b are staggered, or off-set, in relation to each other.

Shown in FIG. 7 is a side view of the laminate core 20 that is positioned between the two longitudinal frame walls 26 and 28 (not shown). It is possible that a fan provides coolant air flow over the projections 36a, 36b provided by the laminate core 20 for helping to dissipate the heat that is absorbed from the electromagnetic coils. As shown, the longitudinal frame wall 26 comprises windows that allow the coolant air to flow out of the frame 24 for better dissipating the heat.

As described above, the electromagnetic coils of the linear induction motor are intended to be helically wound through the continuous coil-receiving slots 38 shown in FIG. 7. The improved efficiency in heat transfer provided by the interleaved projections 36a, 36b provides the possibility to reduce the length of the coil endings which are required for electrical interconnections and heat extraction from the coils. However, the ohmic resistance dissipates energy and their magnetic flux generates electromagnetic interference (EMI). Given that the heat dissipating projections 36a, 36b allow for improved cooling within the core 20, the coil endings can be made shorter and less dissipative. This also reduces the overall cost of the motor, due to lower weight of expensive copper wire.

Although the present invention has been described in considerable detail with reference to certain preferred embodiments thereof, variations and refinements are possible without departing from the spirit of the invention. Therefore, the scope of the invention should be limited only by the appended claims and their equivalents.

1) A core for a primary of a linear induction motor, the core comprising a plurality of laminate sheets of a first type and a plurality of laminate sheets of a second type, wherein:
a) each laminate sheet of the first type comprises a first set of coil-receiving slots and a first set of heat dissipating projections; and
b) each laminate sheet of the second type comprises a second set of coil-receiving slots and a second set of heat dissipating projections;
wherein the core is formed by stacking the plurality of laminate sheets of the first type and the plurality of laminate sheets of the second type in an alternating arrangement, wherein when the first set of coil-receiving slots and the second set of coil-receiving slots are aligned with one another, the first set of heat dissipating projections and the second set of heat dissipating projections are staggered with respect to each other along a longitudinal surface of the core.

2) The core as defined in claim 1, wherein each laminate sheet of the first type and each laminate sheet of the second type is formed of a plurality of laminate layers.

3) The core as defined in claim 2, wherein each laminate sheet comprises between 2 and 6 laminate layers.

4) The core as defined in claim 2, wherein each laminate layer of the plurality of laminate layers has a thickness of between 0.3 and 0.8 mm.

5) The core as defined in claim 2, wherein each laminate layer comprises silicon steel.

6) The core as defined in claim 2, wherein each laminate layer comprises insulation such that the plurality of laminate layers are insulated from one another.

7) The core as defined in claim 1, wherein a pitch between each heat dissipating projection of the first set is the same as a pitch between each heat dissipating projection of the second set.

8) The core as defined in claim 1, wherein the heat dissipating projections of the second set of heat dissipating projections are positioned substantially centrally between adjacent ones of the heat dissipating projections of the first set of heat dissipating projections.

9) The core as defined in claim 1, wherein each heat dissipating projection of the first set of heat dissipating projections and each heat dissipating projection of the second set of heat dissipating projections, comprises:
a) a base portion proximal to a body of a laminate sheet; and
b) a top portion distal from the body of the laminate sheet, wherein a surface area of the top portion is smaller than a surface area of the base portion.

10) The core as defined in claim 9, wherein the top portion has a surface area that is between ½ and ¼ of the surface area of the base portion.

11) The core as defined in claim 9, wherein a width of the base portion is greater than a width of the top portion.

12) The core as defined in claim 11, wherein the width of the base portion is at least twice the width of the top portion.

13) The core as defined in claim 9, wherein each heat dissipating projection of the first set of heat dissipating projections and each heat dissipating projection of the second set of heat dissipating projections comprises a height, wherein a ratio of a width of the base portion of the heat dissipating projection to the height of the heat dissipating projection is between 8 and 13.

14) The core as defined in claim 9, wherein a ratio of a distance between two adjacent heat dissipating projections to a width of the base portion of a heat dissipating projection is between 2 to 4, wherein the distance between two adjacent heat dissipating projections is measured from a center of one heat dissipating projection to a center of an adjacent heat dissipating projection,

15) The core as defined in claim 14, wherein the ratio of the distance between two adjacent heat dissipating projections to the width of the base portion is between 3 to 3.5.

16) The core as defined in claim 1, wherein the set of laminate sheets of the first type and the set of laminate sheets of the second type are kept together in a stacked, alternating, arrangement via at least two bolts.

17) A core for a primary of a linear induction motor, the core comprising a plurality of laminate sheets that are positioned in a stacked arrangement, wherein each of the laminate sheets comprises:
a) a plurality of coil-receiving slots for receiving coil windings of the linear induction motor;
b) a plurality of heat dissipating projections, wherein each heat dissipating projection has a base portion and a top portion, wherein the top portion has a surface area of between 6 mm² and 16 mm² and the base portion has a surface area that is at least double that of the top portion.

18) A core as defined in claim 17, wherein the plurality of laminate sheets are divided into laminate sheets of a first type and laminate sheets of a second type, wherein the laminate sheets of the first type and the laminate sheets of the second type are stacked in an alternating arrangement in order to form the core, wherein when stacked together, the heat dissipating projections of the laminate sheets of the first type are staggered with respect to the laminate sheets of the second type along a longitudinal surface of the core.

19) A core for a primary of a linear induction motor, the core comprising a plurality of laminate sheets positioned between two walls of a frame, each laminate sheet of the plurality of laminate sheets comprising a plurality of heat dissipating projections positioned in a spaced apart manner along a longitudinal edge of the laminate sheet, wherein the heat dissipating projections of each pair of adjacent laminate sheets are staggered from one another such that the core comprises an upper surface defined by a plurality of interleaving heat dissipating projections.

20) The core as defined in claim 19, wherein each laminate sheet is formed of a plurality of laminate layers.
